(19) United States
(12) Patent Application Publication
(10) Pub. No.: US 2025/0202376 A1
(43) Pub. Date: Jun. 19, 2025

(54) CONTROL CIRCUIT OF ISOLATED POWER SUPPLY AND ISOLATED POWER SUPPLY

(71) Applicant: SHANGHAI BRIGHT POWER SEMICONDUCTOR CO., LTD., Shanghai (CN)

(72) Inventors: Pengbo YANG, Shanghai (CN); Zhen ZHU, Shanghai (CN); Yue ZHENG, Shanghai (CN); Jianpei ZHU, Shanghai (CN); Yucai YANG, Shanghai (CN); Shuai WU, Shanghai (CN); Qinyuan TIAN, Shanghai (CN); Fengfan ZHANG, Shanghai (CN)

(21) Appl. No.: 18/964,023

(22) Filed: Nov. 29, 2024

(30) Foreign Application Priority Data
Dec. 15, 2023 (CN) 202311737075.3

(51) Int. Cl. H02M 3/335; H02M 1/38

(52) U.S. Cl. CPC H02M 3/33592; H02M 1/38

(57) ABSTRACT

The present invention provides a control circuit of an isolated power supply and an isolated power supply. A secondary side controller in the control circuit can turn on and off a synchronous rectifier based on a voltage from a secondary side winding, enabling adaptive turn-on and turn-off control of the synchronous rectifier. Specifically, when the voltage from the secondary side winding reaches a second predetermined voltage, an instruction for turning off the synchronous rectifier is provided. The second predetermined voltage is adjusted based on a comparison between a time interval for the previous switching period and a predetermined reference interval. In this way, a delay from a turn-off time of the synchronous rectifier to a turn-on time of a primary transistor switch is substantially maintained at the predetermined reference interval. This prevents cross-conduction of the primary and secondary side circuits, ensuring safe operation of the isolated power supply.

### CROSS-REFERENCES TO RELATED APPLICATION

This application claims the priority of Chinese patent application number 202311737075.3, filed on Dec. 15, 2023, the entire contents of which are incorporated herein by reference.

### TECHNICAL FIELD

The present invention relates to the field of electronic circuits, and in particular to a control circuit of an isolated power supply and an isolated power supply.

### BACKGROUND

In conventional isolated power supplies, a synchronous rectifier in a secondary side circuit is turned on or off typically independently of control logic of a primary transistor switch in a respective primary side circuit. Instead, it is turned on according to a detected slope and/or value of secondary side winding voltage, and turned on upon zero-crossing of the secondary side winding voltage.

However, this mode of control for the synchronous rectifier is associated with a number of problems. For example, in a discontinuous conduction mode (DCM), due to leakage inductance of a transformer or some other reason, natural resonance of the inductor may be misjudged as a sign indicative of a need for turning on the synchronous rectifier, eventually leading to a false turn-on of the synchronous rectifier, and hence degraded conversion efficiency and risk of cross-conduction of the primary and secondary power transistors. Additionally, in a continuous conduction mode (CCM), since the synchronous rectifier is always turned off at a later time than the primary power transistor, there leaves a chance for cross-conduction of the primary transistor switch in the primary side circuit and the synchronous rectifier in the secondary side circuit. When this happens, limiting a current generated during cross-conduction has to be relied on to prevent breakdown, which, however, may lead to an additional degradation in efficiency.

Therefore, there is a need for a control circuit and method capable of preventing cross-conduction of primary and secondary side circuits in an isolated power supply and thereby improving the power supply's safety performance and overall conversion efficiency.

### SUMMARY

It is an objective of the present invention to provide a control circuit of an isolated power supply, which overcomes the problem of cross-conduction of primary and secondary side circuits that tends to arise from the use of conventional isolated power supplies.

To this end, the present invention provides a control circuit for controlling an isolated power supply. The isolated power supply includes a primary side circuit, a secondary side circuit and a transformer coupled between the primary and secondary side circuits. The control circuit includes: a primary side controller having an output terminal electrically connected to a control terminal of a primary transistor switch in the primary side circuit, the primary side controller configured to output a control signal for the primary transistor switch; and a secondary side controller having an input terminal electrically connected to a secondary side winding in the transformer, the secondary side controller configured to detect a voltage from the secondary side winding, the secondary side controller also having an output terminal electrically connected to a control terminal of a synchronous rectifier in the secondary side circuit, the secondary side controller also configured to output a control signal for the synchronous rectifier. In the current switching period, the secondary side controller is configured to give an instruction for turning on the synchronous rectifier when the voltage from the secondary side winding drops to a first predetermined voltage as a result of the primary transistor switch being turned off, and give another instruction for turning off the synchronous rectifier when the voltage from the secondary side winding gradually rises back to a second predetermined voltage in a turn-on period of the synchronous rectifier, the second predetermined voltage is adjusted based on a comparison between a time interval from a turn-off time of the synchronous rectifier for the previous switching period to a time when an ON state of the primary transistor switch is identified in the current switching period and a predetermined reference interval.

Optionally, the secondary side controller may be further configured to identify the ON state of the primary transistor switch upon the voltage from the secondary side winding rising to a third predetermined voltage as a result of the primary transistor switch being turned on.

Optionally, if the time interval for the previous switching period is shorter than the predetermined reference interval, the second predetermined voltage is reduced based on a second predetermined voltage for the previous switching period. Alternatively, if the time interval for the previous switching period is longer than the predetermined reference interval, the second predetermined voltage is reduced based on the second predetermined voltage for the previous switching period.

Optionally, the secondary side controller may be further configured to: determine the turn-off time of the synchronous rectifier for the previous switching period based on a time when the voltage from the secondary side winding reached the second predetermined voltage in the previous switching period and take it as a start time of the time interval for the previous switching period; identify the ON state of the primary transistor switch in the current switching period upon the voltage from the secondary side winding rising to a third predetermined voltage as a result of the primary transistor switch being turned on in the current switching period and take this time as an end time of the time interval for the previous switching period; and thereby determine the time interval for the previous switching period.

Optionally, the secondary side controller may also be configured to generate, while the synchronous rectifier being in an OFF state, a turn-on prompt signal indicating that the primary transistor switch is allowed to be turned on and provide it to the primary side controller.

Optionally, the secondary side controller may include: an adaptive control module having an input terminal electrically connected to the secondary side winding, the adaptive control module configured to receive the voltage from the secondary side winding, determine a turn-on time of the synchronous rectifier as the time when the voltage from the secondary side winding drops to the first predetermined voltage as a result of the primary transistor switch being turned off and determine the turn-off time of the synchronous rectifier as the time when the voltage from the secondary side winding rises back to the second predetermined voltage as a result of the synchronous rectifier being turned on; and a secondary side drive control module having an input terminal electrically connected to the adaptive control module and an output terminal electrically connected to the control terminal of the synchronous rectifier, the secondary side drive control module configured to receive indication signals indicating the turn-on time and the turn-off time of the synchronous rectifier from the adaptive control module and turn on and off the synchronous rectifier based on the indication signals.

Optionally, the adaptive control module may be further configured to determine, in every switching period, an on-time duration of the synchronous rectifier based on the turn-on time and the turn-off time of the synchronous rectifier.

Optionally, the adaptive control module may be further configured to adjust the second predetermined voltage for the current switching period based on the comparison between the time interval and the predetermined reference interval.

Optionally, the adaptive control module may include: a sampling circuit having an input terminal electrically connected to the secondary side winding and configured to sample the voltage from the secondary side winding; a PLL circuit having an input terminal electrically connected to the sampling circuit, the PLL circuit configured to receive the sampled voltage from the secondary side winding, determine the time interval for the previous switching period based on the sampled voltage from the secondary side winding and adjust the second predetermined voltage for the current switching period based on the comparison between the time interval and the predetermined reference interval; and an on-time duration logic circuit having a first input terminal electrically connected to the sampling circuit and a second input terminal electrically connected to the PLL circuit, the on-time duration logic circuit configured to determine the turn-on time of the synchronous rectifier as the time when the voltage from the secondary side winding drops to the first predetermined voltage, receive the second predetermined voltage that has been adjusted by the PLL circuit and determine a turn-off time of the synchronous rectifier as the time when the voltage from the secondary side winding reaches the adjusted second predetermined voltage.

Optionally, the PLL circuit may include: a frequency and phase detector having a first input terminal electrically connected to the sampling circuit, the frequency and phase detector configured to receive the sampled voltage from the secondary side winding and produce a pulse-width signal indicating the time interval for the previous switching period based on the sampled voltage from the secondary side winding, the frequency and phase detector also having a second input terminal for receiving a reference pulse-width signal indicating the predetermined reference interval, the frequency and phase detector also configured to compare the pulse-width signal indicating the time interval for the previous switching period with the reference pulse-width signal and provide a frequency and phase detection result; a current generation unit electrically connected to the frequency and phase detector, the current generation unit configured to: receive the frequency and phase detection result; and generate and output a pull-down current signal if the pulse-width signal indicating the time interval for the previous switching period has a shorter pulse width than the reference pulse-width signal, or generate and output a pull-up current signal of the pulse-width signal indicating the time interval for the previous switching period has a longer pulse width than the reference pulse-width signal; a low-pass filter having an input terminal electrically connected to the current generation unit, the low-pass filter configured to apply low-pass filtering to the output of the current generation unit, the low-pass filter including at least one capacitor, which is charged when the pull-up current signal is received from the current generation unit, or is discharged when the pull-down current signal is received from the current generation unit; and a threshold adjustment unit having an input terminal electrically connected to the low-pass filter, the threshold adjustment unit configured to receive an output voltage from the low-pass filter and obtain the second predetermined voltage for the current switching period by adjusting a second predetermined voltage for the previous switching period based on the output voltage.

Optionally, the adaptive control module may include: a sampling circuit having an input terminal electrically connected to the secondary side winding and configured to sample the voltage from the secondary side winding; a pulse-width comparator having a first input terminal electrically connected to the sampling circuit, the pulse-width comparator configured to produce a pulse-width signal indicating the time interval for the previous switching period based on the voltage from the secondary side winding, the pulse-width comparator also having a second input terminal for receiving a reference pulse-width signal indicating the predetermined reference interval, the pulse-width comparator also configured to compare the pulse-width signal indicating the time interval for the previous switching period with the reference pulse-width signal and provide a pulse-width comparison result; an up/down counter having an input terminal electrically connected to the pulse-width comparator, the up/down counter configured to receive the pulse-width comparison result, determine a count value based on the pulse-width comparison result and produce a counting result based on the count value and a predetermined reference value, wherein if the pulse-width comparison result indicates that the time interval for the previous switching period has a longer pulse width than the reference pulse-width signal, the count value is determined as a positive value, and an output voltage value is increased based on the predetermined reference value and taken as the counting result, or if the pulse-width comparison result indicates that the time interval for the previous switching period has a shorter pulse width than the reference pulse-width signal, the count value is determined as a negative value, and the output voltage value is decreased based on the predetermined reference value and taken as the counting result; a threshold adjustment unit having an input terminal for receiving an analog signal indicating the counting result, the threshold adjustment unit configured to tune the second predetermined voltage for the previous switching period into the second predetermined voltage for the current switching period based on the analog signal; and an on-time duration logic circuit having a first input terminal electrically connected to the sampling circuit and a second input terminal electrically connected to the threshold adjustment unit, the on-time duration logic circuit configured to determine the turn-on time of the synchronous rectifier as the time when the voltage from the secondary side winding drops to the first predetermined voltage, receive the second predetermined voltage that has been adjusted by the threshold adjustment unit and determine a turn-off time of the synchronous rectifier as the time when the voltage from the secondary side winding reaches the adjusted second predetermined voltage.

Optionally, the secondary side controller may further include: a logic module having a second input terminal electrically connected to the secondary side drive control module, the logic module configured to receive from the secondary side drive control module an off-state signal indicating an off-state of the synchronous rectifier and generate a turn-on prompt signal indicating that the primary transistor switch is allowed to be turned on; and a transmitter module having an input terminal electrically connected to the logic module and an output terminal electrically connected to the primary side controller, the transmitter module configured to receive the turn-on prompt signal and pass it on to the primary side controller.

Optionally, the secondary side controller may further include: a loop module having an input terminal for receiving an output voltage of the isolated power supply and an output terminal electrically connected to a first input terminal of the logic module, the loop module configured to generate a feedback signal based on the output voltage of the isolated power supply and provide the feedback signal to the logic module; and the logic module configured to generate the turn-on prompt signal based on the off-state signal and the feedback signal.

The present invention also provides an isolated power supply including the control circuit as defined above.

In the control circuit of the present invention, the secondary side controller can provide an instruction for turning on the synchronous rectifier when the voltage from the secondary side winding drops to the first predetermined voltage as a result of the primary transistor switch being turned off. Moreover, it can provide another instruction for turning off the synchronous rectifier when the voltage from the secondary side winding gradually rises back to the second predetermined voltage as a result of the synchronous rectifier being turned on. This enables adaptive turn-on and turn-off control of the synchronous rectifier. The second predetermined voltage that serves as a basis for turning off the synchronous rectifier in the current switching period may have been adjusted based on a comparison between a time interval from a turn-off time of the synchronous rectifier for the previous switching period to a time when an ON state of the primary transistor switch is identified by the secondary side controller in the current switching period and the predetermined reference interval. In other words, the second predetermined voltage for the current switching period may have been maintained, increased or decreased based on a difference between the time interval for the previous switching period and the predetermined reference interval. In this way, in the current switching period, determining a turn-off time for the synchronous rectifier based on the adjusted second predetermined voltage means applying an adaptive adjustment to an on-time period of the synchronous rectifier. This predictive control allows a delay from the turn-off time of the synchronous rectifier to a turn-on time of the primary transistor switch to be substantially kept at the predetermined reference interval, thereby preventing cross-conduction of the primary and secondary side circuits and ensuring safe operation of the isolated power supply.

### BRIEF DESCRIPTION OF THE DRAWINGS

FIG. 1 is a schematic circuit diagram of an isolated power supply coupled to a control circuit according to an embodiment of the present invention.

FIG. 2 is a schematic circuit diagram of an adaptive control module in the control circuit according to an embodiment of the present invention.

FIG. 3 is a schematic circuit diagram of alternative adaptive control module in the control circuit according to an embodiment of the present invention.

FIG. 4 is a schematic waveform diagram of key signals in an isolated power supply according to an embodiment of the present invention.

### DETAILED DESCRIPTION

Control circuits and isolated power supplies according to the present invention will be described in greater detail below with reference to the accompanying drawings, which illustrate specific embodiment thereof. From the following description, advantages and features of the invention will become apparent. Note that the figures are provided in a very simplified form not necessarily drawn to exact scale for the only purpose of helping to explain the disclosed embodiments in a more convenient and clearer way. As used herein, the terms “on-time period” and “on-time” each refer to a period of time, the term “time” refers to a period of time or an instant, and the terms “instant”, “when” and “turn-off time” each refer to a point of time at which an event occurs. As used herein, the terms “valid level” and “high level” each refer to an electrical level indicative of an action to be taken by a designated element or module, which is detectable and determined to be valid, and the terms “invalid level” and “low level” each refer to an electrical level indicative of an action to be taken by a designated element or module, which is detectable but determined to be invalid, or is undetectable. The term “signal” refers to an electrical/magnetic signal, which can be represented by a particular waveform, or to information transmitted in a circuit, which can be represented by a particular value.

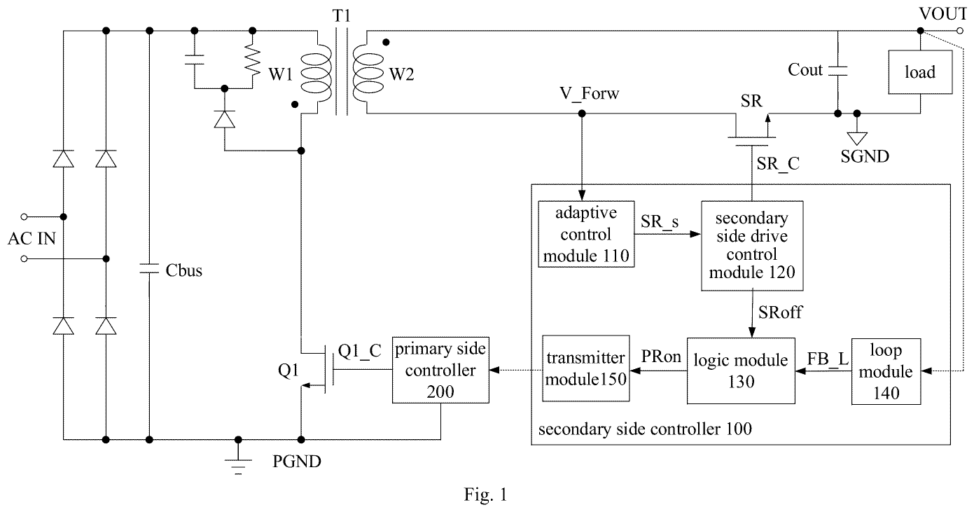

FIG. 1 is a schematic circuit diagram of an isolated power supply coupled to a control circuit according to an embodiment of the present invention. As shown in FIG. 1, the isolated power supply includes a primary side circuit, a secondary side circuit and a transformer T1, which is coupled between the primary and secondary side circuits to provide electrical isolation. The primary and secondary side circuits are electrically isolated from each other and connected to different ground terminals. The transformer T1 includes a primary side winding W1 and a secondary side winding W2. The primary side circuit is coupled to the primary side winding W1 in the transformer T1, and the secondary side circuit is coupled to the secondary side winding W2 in the transformer T1.

In one example, the primary side circuit may include an input capacitor Cbus and a primary transistor switch Q1. A first terminal of the input capacitor Cbus is coupled to the primary side winding W1 of the transformer T1, and a second terminal of the input capacitor Cbus is connected to the ground terminal for the primary side circuit. For example, the primary transistor switch Q1 may be a power switch transistor. A drain of the power switch transistor is connected to the primary side winding W1 of the transformer T1. A source of the power switch transistor is connected to the ground terminal for the primary side circuit. A gate of the power switch transistor is connected to a primary side controller 200, in order to receive a control signal Q1_C for the primary transistor switch Q1.

In one example, the secondary side circuit may include a synchronous rectifier SR and an output capacitor Cout. A first terminal of the output capacitor Cout is coupled to the secondary-side winding W2 of the transformer T1 and to a load. A second terminal of the output capacitor Cout is connected to the ground terminal for the secondary-side circuit. For example, the synchronous rectifier SR may be a power switch transistor. A drain of the power switch transistor is connected to the secondary-side winding W2 of the transformer T1. A source of the power switch transistor is connected to the ground terminal for the secondary-side circuit. A gate of the power switch transistor is connected to a secondary side controller 100, in order to receive a control signal SR_C for the synchronous rectifier SR.

With continued reference to FIG. 1, the control circuit includes the primary side controller 200 and the secondary side controller 100. The primary side controller 200 has an output terminal, which is electrically connected to the control terminal of the primary transistor switch Q1 in the primary side circuit, in order to output the control signal Q1_C for the primary transistor switch Q1 thereto to turn on or off the primary transistor switch Q1. The secondary side controller 100 has an output terminal, which is electrically connected to the control terminal of the synchronous rectifier SR in the secondary side circuit, in order to output the control signal SR_C for the output synchronous rectifier SR thereto to turn on or off the synchronous rectifier SR. That is, the primary side controller 200 can be used to turn on or off the primary transistor switch Q1, and the secondary side controller 100 can be used to turn on or off the synchronous rectifier SR.

The secondary side controller 100 also has a first input terminal, which is coupled to the secondary side winding W2 of the transformer T1, in order to receive a voltage V_Forw from the secondary side winding W2 in the transformer T1. The secondary side controller 100 can determine if the primary transistor switch Q1 in the primary side circuit is ON or OFF from the sensed voltage V_Forw from the secondary side winding W2.

Specifically, in a given switching period, once the primary transistor switch Q1 is turned on, the voltage V_Forw from the secondary side winding W2 may experience a sharp increase. In this process, upon the voltage V_Forw from the secondary side winding W2 rising to a third predetermined voltage Vth3, the secondary side controller 100 can determine that the primary transistor switch Q1 in the primary side circuit is in an ON state. After the primary transistor switch Q1 is turned off, the voltage V_Forw from the secondary side winding W2 will experience a sharp decrease. In this process, when the secondary side controller 100 detects that the voltage V_Forw from the secondary side winding W2 drops to a first predetermined voltage Vth1, it may give an instruction for turning on the synchronous rectifier SR. Moreover, while the synchronous rectifier SR being ON, the voltage V_Forw from the secondary side winding W2 will gradually rise, and as soon as it reaches a second predetermined voltage Vth2, the secondary side controller 100 may give an instruction for turning off the synchronous rectifier SR. That is, within every switching period, during a sharp increase of the voltage V_Forw from the secondary side winding W2 as a result of the primary transistor switch Q1 being turned on, the third predetermined voltage Vth3 can as a basis for the secondary side controller 200 to identify an ON state of the primary transistor switch Q1. In addition, during a sharp decrease of the voltage V_Forw from the secondary side winding W2 as a result of the primary transistor switch Q1 being turned off, the first predetermined voltage Vth1 can serve as a basis for triggering turn-on of the synchronous rectifier SR, i.e., as a basis for issuing an instruction for turning on the synchronous rectifier SR upon the voltage V_Forw from the secondary side winding W2 decreasing to the first predetermined voltage Vth1. Further, during a gradual rise of the voltage V_Forw from the secondary side winding W2 as a result of the synchronous rectifier SR being turned on, the second predetermined voltage Vth2 can serve as a basis for triggering turn-off of the synchronous rectifier SR, i.e., as a basis for giving an instruction for turning off the synchronous rectifier SR when the voltage V_Forw from the secondary side winding W2 reaches the second predetermined voltage Vth2.

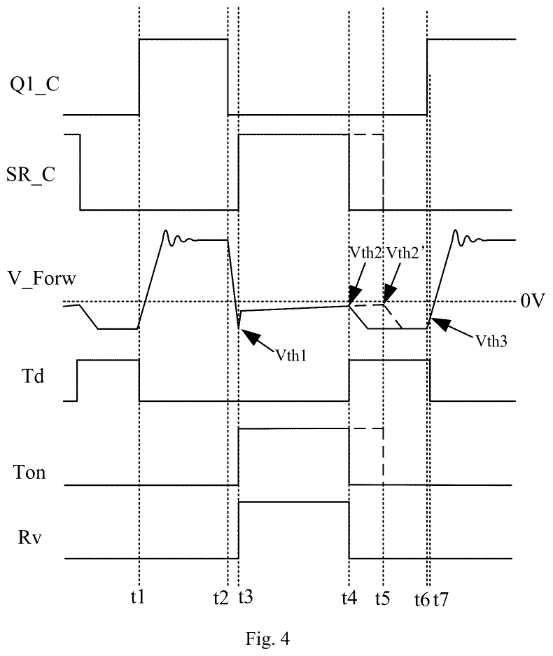

As an example, as shown in FIG. 4, in a given switching period, the primary transistor switch Q1 is turned on at time t1, causing the voltage V_Forw from the secondary side winding W2 to rise sharply to the third predetermined voltage Vth3 within a very short time, and this can be detected by the secondary side controller 200. At t2, the primary transistor switch Q1 is turned off, causing a sharp decrease of the voltage V_Forw from the secondary side winding W2. At t3, the voltage drops to the first predetermined voltage Vth1, and the synchronous rectifier SR can be turned on at this time. Consequently, the voltage V_Forw from the secondary side winding W2 gradually rises back from t3 to t4, and reaches the second predetermined voltage Vth2 at t4. At this time, the synchronous rectifier SR can be turned off. In a specific example, the control signal SR_C for the synchronous rectifier SR may be inverted at t3, for example, to transition from a low level to a high level, as shown in FIG. 4, providing an instruction for turning on the synchronous rectifier SR. Additionally, the control signal SR_C for the synchronous rectifier SR may be again inverted at t4, for example, to transition from the high level back to the low level, as shown in FIG. 4, given an instruction for turning off the secondary synchronous rectifier.

In particular, the second predetermined voltage Vth2 that serves as a basis for providing an instruction for turning off the synchronous rectifier SR may be adjusted based on a comparison between a time interval Td from an off-time of the synchronous rectifier SR for the previous switching period to the time when an ON state of the primary transistor switch Q1 is identified in the current switching period and a predetermined reference interval Tdref. Specifically, the time interval Td from an off-time of the synchronous rectifier SR for the previous switching period to the time when an ON state of the primary transistor switch Q1 is identified in the current switching period is taken as the time interval Td for the previous switching period. In a specific example, a time interval Td for the current switching period may be adjusted based on a comparison between the time interval Td for the previous switching period and the predetermined reference interval Tdref so as to lie within the predetermined reference interval Tdref. This can ensure a sufficient time interval between turn-on times of the synchronous rectifier SR and the primary transistor switch Q1 in the adjacent switching periods, which in turn ensures that the primary transistor switch G1 is turned on while the synchronous rectifier SR is being in an OFF state in the next switching period, effectively reducing the risk of cross-conduction of the primary and secondary sides.

In this embodiment, the time interval Td for the current switching period may be particularly adjusted by tuning the value of the second predetermined voltage Vth2. Specifically, the time interval Td for the previous switching period is shorter than the predetermined reference interval Tdref, the second predetermined voltage Vth2 may be decreased from the value for the previous switching period, making the time interval Td for the current switching period closer to the predetermined reference interval Tdref. This is equivalent to turning the synchronous rectifier SR off at an earlier time than the previous switching period. On the contrary, when the time interval Td for the previous switching period is longer than the predetermined reference interval Tdref, the second predetermined voltage Vth2 may be increased from the value for the previous switching period, making the time interval Td for the current switching period closer to the predetermined reference interval Tdref. This is equivalent to turning the synchronous rectifier SR off at a later time than the previous switching period.

For example, as shown in FIG. 4, when the time interval Td for the previous switching period is longer than the predetermined reference interval Tdref, the value of the second predetermined voltage for the current switching period may be increased (from Vth2 to Vth2′), deferring the turn-off time for the synchronous rectifier SR from t3 to t4 and thereby extending the on-time period Ton of the synchronous rectifier SR (from t3-t4 to t3-t5). As a result, the time interval Td becomes closer to the predetermined reference interval Tdref.

In a specific example, the value of the second predetermined voltage Vth2 may be adjusted by the secondary side controller 100. That is, the secondary side controller 100 may adjust the second predetermined voltage Vth2 for the current switching period based on a comparison between the time interval Td for the previous switching period and the predetermined reference interval Tdref.

Therefore, the control circuit for the isolated power supply of this embodiment can increase, decrease or maintain the value of the second predetermined voltage Vth2 based on a difference between the time interval Td for the previous switching period and the predetermined reference interval Tdref. In this way, the synchronous rectifier SR can be turned off in the current switching period at an appropriate time based on the second predetermined voltage Vth2. Moreover, the on-time period Ton of the synchronous rectifier SR can be adaptively adjusted to ensure a delay from the turn-off time of the synchronous rectifier SR to the turn-on time of the primary transistor switch Q1, which is substantially kept around the predetermined reference interval Tdref. This can prevent cross-conduction of the primary and secondary side circuits and ensure safe operation of the isolated power supply.

As an example, the secondary side controller 100 may particularly take the time when the voltage V_Forw from the secondary side winding W2 reached the second predetermined voltage Vth2 in the previous switching period as a turn-off time of the synchronous rectifier SR for the previous switching period and also as a start time of the time interval Td for the previous switching period. Moreover, in the current switching period, the secondary side controller 100 may identify an ON state of the primary transistor switch Q1 when the voltage V_Forw from the secondary side winding W2 rises to the third predetermined voltage Vth3 as a result of the primary transistor switch Q1 being turned on and take this time as an end time of the time interval Td for the previous switching period, thereby determining the time interval Td for the previous switching period. Likewise, the secondary side controller 100 may take the time when the voltage V_Forw from the secondary side winding W2 reaches the second predetermined voltage Vth2 in the current switching period as a turn-off time of the synchronous rectifier SR and also as a start time of the time interval Td for the current switching period. Moreover, in the next switching period, it may identify an ON state of the primary transistor switch Q1 when the voltage V_Forw from the secondary side winding W2 rises to the third predetermined voltage Vth3 and take this time as an end time of the time interval Td for the current switching period, thereby determining the time interval Td for the switching period.

For example, as shown in FIG. 4, in the current switching period, the synchronous rectifier SR may be turned on at t4 (or t5), and a signal indicative of the time interval Td may be inverted high, marking the start of the time interval Td. In the next switching period, the primary transistor switch Q1 may be turned on at t6, and the voltage V_Forw from the secondary side winding W2 may rise to the third predetermined voltage Vth3 at t7. At this time, the signal indicating the time interval Td may be inverted low, marking the end of the time interval Td.

In practical applications, the value of the third predetermined voltage Vth3 may be adjusted as desired. For example, in the example of FIG. 4, the third predetermined voltage Vth3 may be slightly higher than the lowest value of the voltage V_Forw from the secondary side winding W2 within the switching period. In this way, the end of the time interval Td can be faster identified, making the determined time interval Td closer to the actual value.

Additionally, with continued reference to FIG. 1, the secondary side controller 100 may generate, while the synchronous rectifier SR being in an OFF state, a turn-on prompt signal PRon indicating that the primary transistor switch Q1 is now allowed to be turned on and transmit the signal PRon to the primary side controller 200 to prompt the primary side controller 200 to turn on the primary transistor switch Q1 in the primary side circuit to start the next switching period.

A specific configuration of the control circuit is described in detail below with continued reference to FIG. 1. As shown in FIG. 1, the secondary side controller 100 may particularly include an adaptive control module 110 and a secondary side drive control module 120.

An input terminal of the adaptive control module 110 is electrically connected to the secondary side winding W2, and an output terminal of the adaptive control module 110 is connected to an input terminal of the secondary side drive control module 120. An output terminal of the secondary side drive control module 120 is electrically connected to the control terminal of the synchronous rectifier SR.

Specifically, the adaptive control module 110 is electrically connected to the secondary side winding W2, in order to receive the voltage V_Forw from the secondary side winding W2. In every switching period, the adaptive control module 110 can determine the time when the voltage V_Forw from the secondary side winding W2 drops to the first predetermined voltage Vth1 as a result of the primary transistor switch Q1 being turned off as a turn-on time of the synchronous rectifier SR, the time when the voltage V_Forw from the secondary side winding W2 rises back to the second predetermined voltage Vth2 as a turn-off time of the synchronous rectifier SR, and an on-time period Ton of the synchronous rectifier SR from the turn-on and turn-off times of the synchronous rectifier SR.

Additionally, the adaptive control module 110 is configured to adjust the second predetermined voltage Vth2 for the current switching period based on a comparison between a time interval Td from an off-time of the synchronous rectifier SR for the previous switching period to the time when an ON state of the primary transistor switch Q1 is identified in the current switching period and the predetermined reference interval Tdref.

The adaptive control module 110 has another output terminal, which is electrically connected to the secondary side drive control module 120, in order to provide indication signals SR_s indicating the turn-on time and turn-off time of the synchronous rectifier SR to the secondary side drive control module 120. The secondary side drive control module 120 can be based on the indication signals SR_s to turn on or off the synchronous rectifier SR.

With continued reference to FIG. 1, the secondary side controller 100 includes a logic module 130, a loop module 140 and a transmitter module 150. The loop module 140 is configured to receive, at an input terminal thereof, an output voltage Vout of the isolated power supply, and an output terminal of the loop module 140 is electrically connected to a first input terminal of the logic module 130. A second input terminal of the logic module 130 is electrically connected to the secondary side drive control module 120, and an output terminal of the logic module 130 is electrically connected to an input terminal of the transmitter module 150. An output terminal of the transmitter module 150 is electrically connected to the primary side controller 200.

Specifically, the secondary side drive control module 120 is configured to generate an off-state signal SRoff while the synchronous rectifier SR is being OFF and provide the signal SRoff to the logic module 130. The loop module 140 is configured to generate a feedback signal FB_L based on the output voltage Vout of the isolated power supply and provide the feedback signal FB_L to the logic module 130. The logic module 130 is configured to generate, based on the off-state signal SRoff and the feedback signal FB_L, a turn-on prompt signal PRon indicating that the primary transistor switch Q1 in the primary side circuit is now allowed to be turned on, and provide it to the transmitter module 150. The transmitter module 150 passes the turn-on prompt signal PRon on to the primary side controller 200 to prompt it to turn on the primary transistor switch Q1 in the primary side circuit. The transmitter module 150 may be an optocoupler, which may operate in the same way as a known optocoupler used in a conventional isolated flyback power supply.

In a specific example, the adaptive control module 110 determines the turn-on time and turn-off time for the synchronous rectifier SR based on the voltage V_Forw from the secondary side winding W2 and provides indication signals SR_s indicative of the turn-on time and turn-off time of the synchronous rectifier SR to the secondary side drive control module 120, which then turns on or off the synchronous rectifier SR based on the indication signals SR_s. While the synchronous rectifier SR is being OFF, the secondary side drive control module 120 generates and transmits an off-state signal SRoff to the logic module 130. Upon receipt of the off-state signal SRoff, the logic module 130 generates a turn-on prompt signal PRon based on both the off-state signal SRoff and a feedback signal FB_L from the loop module 140, and outputs it to the transmitter module 150. The transmitter module 150 passes the turn-on prompt signal PRon on to the primary side controller 200 to prompt the primary side controller 200 to turn on the primary transistor switch Q1 in the primary side circuit.

The adaptive control module 110 may determine the turn-off time of the synchronous rectifier SR based on the time when the voltage V_Forw from the secondary side winding W2 gradually rises back to the second predetermined voltage Vth2 while the synchronous rectifier SR is being OFF. The second predetermined voltage Vth2 may be adjusted based on a comparison between a time interval Td from an off-time for the synchronous rectifier SR in the previous switching period to the time when an ON state of the primary transistor switch Q1 in the current switching period is identified with the predetermined reference interval Tdref. Therefore, the second predetermined voltage Vth can be adjusted to maintain, advance or defer the turn-off time of the synchronous rectifier SR to adjust its on-time period Ton or not. The adaptively adjustable on-time period Ton for the synchronous rectifier SR allows the time interval Td for the current switching period to be kept substantially around the predetermined reference interval Tdref.

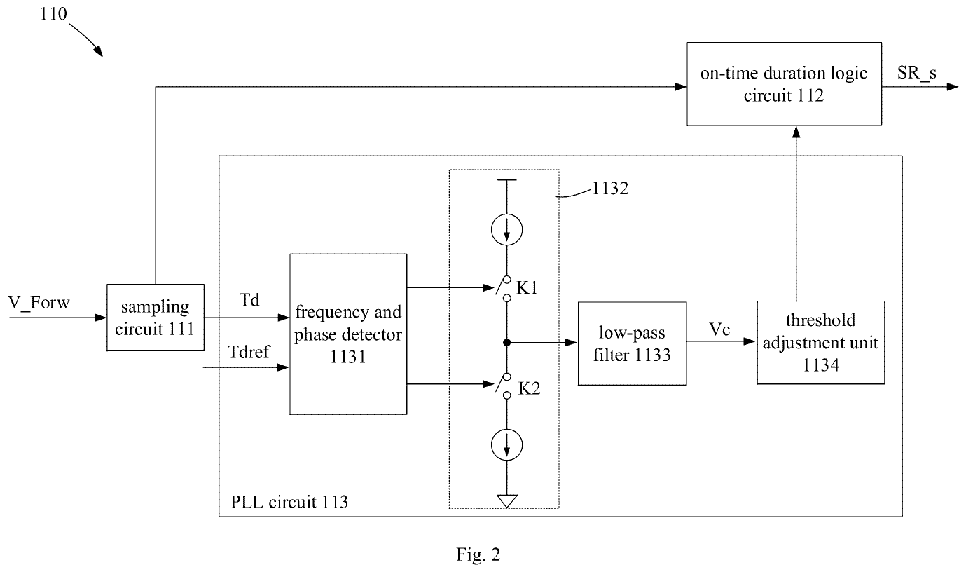

In one example, with particular reference to FIG. 2, the adaptive control module 110 may include a sampling circuit 111, a phase-locked loop (PLL) circuit 113 and an on-time duration logic circuit 112.

An input terminal of the sampling circuit 111 is electrically connected to the secondary side winding W2, and an input terminal of the PLL circuit 113 is electrically connected to the sampling circuit 111. An output terminal of the PLL circuit 113 is electrically connected to a first input terminal of the on-time duration logic circuit 112, and a second input terminal of the on-time duration logic circuit 112 is electrically connected to the sampling circuit 111.

Specifically, the sampling circuit 111 is configured to sample the voltage from the secondary side winding W2 and provide the sampled voltage to the PLL circuit 113 and the on-time duration logic circuit 112. The PLL circuit 113 is configured to receive the sampled voltage and determine the time interval Td for the previous switching period based on the voltage V_Forw from the secondary side winding W2. It is also configured to adjust the second predetermined voltage Vth2 for the current switching period based on a comparison between the time interval Td and the predetermined reference interval Tdref. The adjusted second predetermined voltage Vth2 is provided to the on-time duration logic circuit 112. The on-time duration logic circuit 112 is configured to determine a turn-on time of the synchronous rectifier SR based on the time when the voltage V_Forw from the secondary side winding W2 drops to the first predetermined voltage Vth1, receive the adjusted second predetermined voltage Vth2 that has been adjusted in the PLL circuit 113, and determine a turn-off time of the synchronous rectifier SR based on the time when the voltage V_Forw from the secondary side winding W2 reaches the adjusted second predetermined voltage Vth2.

In a specific example, with continued reference to FIG. 2, the PLL circuit 113 may particularly include a frequency and phase detector 1131, a current generation unit 1132, a low-pass filter 1133 and a threshold adjustment unit 1134.

The input terminal of the sampling circuit 111 is electrically connected to the secondary side winding W2, and a first output terminal of the sampling circuit 111 is electrically connected to the on-time logic duration circuit 112. A second output terminal of the sampling circuit 111 is electrically connected to the frequency and phase detector 1131 in the PLL circuit 113. A first input terminal of the frequency and phase detector 1131 is electrically connected to the sampling circuit 111, and a second input terminal of the frequency and phase detector 1131 is configured to receive a reference pulse-width signal indicative of the predetermined reference interval Tdref. An output terminal of the frequency and phase detector 1131 is electrically connected to the current generation unit 1132. An output terminal of the current generation unit 1132 is electrically connected to an input terminal of the low-pass filter 1133, and an output terminal of the low-pass filter 1133 is electrically connected to an input terminal of the threshold adjustment unit 1134. An output terminal of the threshold adjustment unit 1134 is electrically connected to the on-time duration logic circuit 112.

For example, the sampling circuit 111 samples the voltage V_Forw from the secondary side winding W2 and provides it to the on-time duration logic circuit 112. The on-time duration logic circuit 112 is configured to determine turn-on and turn-off times of the synchronous rectifier SR based on the voltage V_Forw from the secondary side winding W2, generate corresponding indication signal SR_s and provide the indication signal SR_s to the secondary side drive control module 120. The on-time duration logic circuit 112 is also configured to determine an on-time period Ton for the synchronous rectifier SR in every switching period. Specifically, the on-time duration logic circuit 112 is configured to determine a turn-on time of the synchronous rectifier SR based on the time when the voltage V_Forw from the secondary side winding W2 drops to the first predetermined voltage Vth1 as a result of the primary transistor switch Q1 being turned off. The on-time logic duration circuit 112 is also configured to determine a turn-off time of the synchronous rectifier SR based on the time when the voltage V_Forw from the secondary side winding W2 rises back to the second predetermined voltage Vth2. Thus, it can determine an on-time period Ton for the synchronous rectifier SR in every switching period.

For example, the sampling circuit 111 samples the voltage V_Forw from the secondary side winding W2 and provides the sampled voltage to the frequency and phase detector 1131 in the PLL circuit 113. The frequency and phase detector 1131 is configured to derive, based on the voltage V_Forw from the secondary side winding W2, a pulse-width signal indicative of a time interval Td (for the previous switching period) from a turn-off time of the synchronous rectifier SR in the previous switching period to the time when an ON state of the primary transistor switch Q1 is identified in the current switching period. The frequency and phase detector 1131 is also configured to receive the reference pulse-width signal that indicates the predetermined reference interval Tdref, compare the pulse-width signal for the previous switching period with the reference pulse-width signal, and provide a frequency and phase detection result. The comparison between the pulse-width signal for the previous switching period and the reference pulse-width signal may be a pulse-width comparison made by the frequency and phase detector 1131 using a known technique, which is, however, not described in any greater detail to avoid obscuring the present disclosure. Notably, the frequency and phase detector 1131 is used mainly to compare the pulse widths of the two signals, and this disclosure is not limited to any particular frequency and phase detector commonly used in the art.

The current generation unit 1132 is configured to generate and output a pull-down current signal (e.g., an output current from a second charge pump connected to the frequency and phase detector 1131 via a second switch K2, as shown in FIG. 2) if the pulse-width signal for the previous switching period has a shorter pulse width than the reference pulse-width signal (i.e., Td<Tdref). It is also configured to generate and output a pull-up current signal (e.g., an output current from a first charge pump connected to the frequency and phase detector 1131 via a first switch K1, as shown in FIG. 2) if the pulse-width signal for the previous switching period has a longer pulse width than the reference pulse-width signal (i.e., Td>Tdref).

For example, the current generation unit 1122 may include the first charge pump and the second charge pump. An output terminal of the first charge pump is electrically connected to the input terminal of the low-pass filter 1133 via the first switch K1, and an input terminal of the second charge pump is electrically connected to the input terminal of the low-pass filter 1133 via the second switch K2. The current generation unit 1122 is configured to turn on the first switch K1 or the second switch K2 based on the frequency and phase detection result output from the frequency and phase detector 1131. If the frequency and phase detection result indicates that the pulse width of the pulse-width signal for the previous switching period is longer than that of the reference pulse-width signal (i.e., Td>Tdref), the first switch K1 is turned on to allow a capacitor in the low-pass filter 1133 to be charged. If the frequency and phase detection result indicates that the pulse width of the pulse-width signal for the previous switching period is shorter than that of the reference pulse-width signal (i.e., Td<Tdref), the second switch K2 is turned on to allow the capacitor in the low-pass filter 1133 to be discharged.

For example, the low-pass filter 1133 is configured to apply low-pass filtering to the output of the current generation unit 1132, and the filtered electrical signal is output to the threshold adjustment unit 1134. The low-pass filter 1133 may particularly include at least one capacitor, which is charged when the pull-up current signal is received, or discharged when the pull-down current signal is received. The electrical signal (which may be a current or voltage signal) output from the low-pass filter 1133 is fed to the threshold adjustment unit 1134.

For example, the threshold adjustment unit 1134 may be configured to adjust, based on the electrical signal output from the low-pass filter 1133, the second predetermined voltage Vth2 for the previous switching period into a value for the current switching period. Specifically, when the pulse width of the pulse-width signal that indicates the time interval Td for the previous switching period is longer than that of the reference pulse-width signal (i.e., Td>Tdref), the first switch K1 is turned on to allow the capacitor in the low-pass filter 1133 to be charged to increase the output voltage Vc and hence the second predetermined voltage Vth2 for the current switching period. When the pulse width of the pulse-width signal that indicates the time interval Td for the previous switching period is shorter than that of the reference pulse-width signal (i.e., Td<Tdref), the second switch K2 is turned on to allow the capacitor in the low-pass filter 1133 to be discharged to decrease the output voltage Vc and hence the second predetermined voltage Vth2 for the current switching period.

The output terminal of the threshold adjustment unit 1134 is electrically connected to the on-time duration logic circuit 112, in order to provide the adjusted second predetermined voltage Vth2 for the current switching period to the on-time duration logic circuit 112 to allow the on-time duration logic circuit 112 to determine a turn-off time of the synchronous rectifier SR for the current switching period based on the second predetermined voltage Vth2.

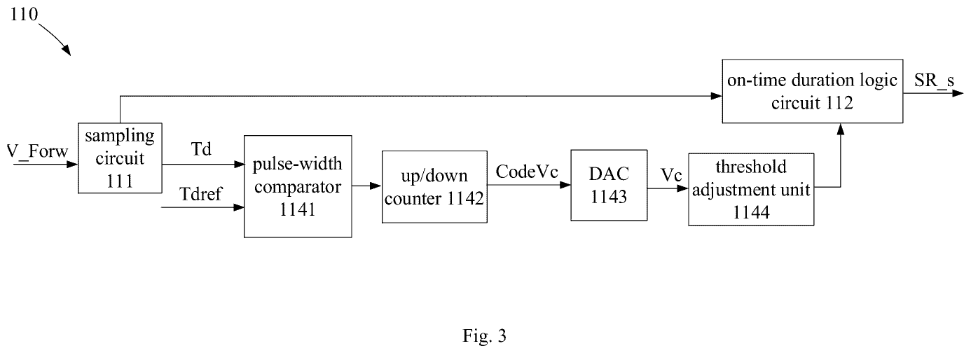

In another example, with particular reference to FIG. 3, the adaptive control module 110 may include a sampling circuit 111, an on-time duration logic circuit 112, a pulse-width comparator 1141, an up/down counter 1142, a digital-to-analog converter (DAC) 1143 and a threshold adjustment unit 1144.

A first output terminal of the sampling circuit 111 is electrically connected to an input terminal of the on-time duration logic circuit 112, and a second output terminal of the sampling circuit 111 is electrically connected to the pulse-width comparator 1141. A first input terminal of the pulse-width comparator 1141 is electrically connected to an output terminal of the sampling circuit 111, and a second input terminal of the pulse-width comparator 1141 is configured to receive the reference pulse-width signal indicating the predetermined reference interval Tdref. An output terminal of the pulse-width comparator 1141 is electrically connected to an input terminal of the up/down counter 1142, and an output terminal of the up/down counter 1142 is electrically connected to an input terminal of the DAC 1143. An output terminal of the DAC 1143 is electrically connected to an input terminal of the threshold adjustment unit 1144, and an output terminal of the threshold adjustment unit 1144 is electrically connected to the on-time duration logic circuit 112.

For example, the sampling circuit 111 samples the voltage V_Forw from the secondary side winding W2 and provides the sample voltage to the on-time duration logic circuit 112. The on-time duration logic circuit 112 is configured to determine turn-on and turn-off times of the synchronous rectifier SR based on the voltage V_Forw from the secondary side winding W2, generate corresponding indication signal SR_s and provide the indication signal SR_s to the secondary side drive control module 120. The on-time duration logic circuit 112 is also configured to determine an on-time period Ton for the synchronous rectifier SR in every switching period. Specifically, the on-time duration logic circuit 112 is configured to determine a turn-on time of the synchronous rectifier SR based on the time when the voltage V_Forw from the secondary side winding W2 drops to the first predetermined voltage Vth1 as a result of the primary transistor switch Q1 being turned off. The on-time duration logic circuit 112 is also configured to determine a turn-off time of the synchronous rectifier SR based on the time when the voltage V_Forw from the secondary side winding W2 rises back to the second predetermined voltage Vth2. Thus, it can determine an on-time period Ton for the synchronous rectifier SR in every switching period.

For example, the sampling circuit 111 samples the voltage V_Forw from the secondary side winding W2 and provides the sampled voltage to the pulse-width comparator 1141. The pulse-width comparator 1141 is configured to derive, based on the voltage V_Forw from the secondary side winding W2, a pulse-width signal indicative of a time interval Td (for the previous switching period) from a turn-off time of the synchronous rectifier SR in the previous switching period to the time when an ON state of the primary transistor switch Q1 is identified in the current switching period. The pulse-width comparator 1141 is also configured to receive a reference pulse-width signal indicative of the predetermined reference interval, compare the pulse-width signal for the previous switching period with the reference pulse-width signal, and provide a pulse-width comparison result. That is, the pulse-width comparator 1141 is used to determine, generate and output a pulse-width comparison result indicating, which of the pulse-width signal for the previous switching period and the reference pulse-width signal has a longer or shorter pulse width than the other. The pulse-width comparator 1141 may accomplish the comparison, generation and outputting using known techniques (e.g., the pulse-width signal and the reference pulse-width signal may be separately applied to charge a capacitor at a constant rate, and a comparison may be then made between the resulting voltages), which are, however, not described in any greater detail to avoid obscuring the present disclosure.

For example, the up/down counter 1142 receives the pulse-width comparison result from the pulse-width comparator 1141, determines a count value based on the pulse-width comparison result, and produces a counting result CodeVc based on the count value and a predetermined reference value. If the pulse-width comparison result indicates that the pulse-width signal for the previous switching period has a longer pulse width than the reference pulse-width signal (i.e., Td>Tdref), the count value is positive. In this case, the up/down counter 1142 adaptively increases its output while taking into account the predetermined reference value and takes the resulting output as the counting result Code Vc. If the pulse-width comparison result indicates that the pulse width of the pulse-width signal for the previous switching period is shorter than that of the reference pulse-width signal (i.e., Td<Tdref), the count value is negative. In this case, the up/down counter 1142 adaptively decreases the output while taking into account the predetermined reference value and takes the resulting output as the counting result Code Vc.

For example, the DAC 1143 receives the counting result Code Vc output from the up/down counter 1142 in the form of a digital signal and applies digital-to-analog conversion to the counting result Code Vc, producing an analog signal Vc indicating the counting result Code Vc.

For example, the threshold adjustment unit 1144 is configured to adjust, based on the analog signal Vc indicating the counting result CodeVc, the second predetermined voltage Vth2 for the previous switching period into a value for the current switching period. Specifically, when the pulse width of the pulse-width signal that indicates the time interval Td for the previous switching period is longer than that of the reference pulse-width signal (i.e., Td>Tdref), the counting result CodeVc generated by the up/down counter 1142 is increased while taking into account the predetermined reference value, resulting in an increase in the analog signal Vc output from the DAC 1143, and hence an increase in the second predetermined voltage Vth2 for the current switching period, which is caused by the threshold adjustment unit 1144 based on the increase in the analog signal Vc. When the pulse width of the pulse-width signal that indicates the time interval Td for the previous switching period is shorter than that of the reference pulse-width signal (i.e., Td<Tdref), the counting result CodeVc generated by the up/down counter 1142 is decreased while taking into account the predetermined reference value, resulting in a decrease in the analog signal Vc output from the DAC 1143, and hence a decrease in the second predetermined voltage Vth2 for the current switching period, which is caused by the threshold adjustment unit 1144 based on the decrease in the analog signal Vc.

In addition, the output terminal of the threshold adjustment unit 1144 is electrically connected to the on-time duration logic circuit 112, in order to provide the second predetermined voltage Vth2 for the current switching period to the on-time duration logic circuit 112 to allow the on-time duration logic circuit 112 to determine a turn-off time of the synchronous rectifier SR for the current switching period based on the adjusted second predetermined voltage Vth2.

In order to more clearly illustrate current control according to the present disclosure for adaptively adjusting an on-time period Ton of the synchronous rectifier SR and hence effectively preventing cross-conduction of the primary and secondary side circuits and ensuring safe operation of the isolated power supply, a process performed by the control circuit according to any of the foregoing embodiments based on the key signals having the waveforms shown in FIG. 4 to adjust the second predetermined voltage Vth2 based on a comparison between a time interval Td for the previous switching period and the predetermined reference interval Tdref and determine a turn-off time of the synchronous rectifier SR for the current switching period based on the adjusted second predetermined voltage Vth2 is explained in detail below.

At time t1 in the current switching period, the primary transistor switch Q1 is turned on, causing the voltage V_Forw from the secondary side winding W2 to sharply increase to the third predetermined voltage Vth3. At the same time, the secondary side controller 100 identifies an ON state of the primary transistor switch Q1 and causes the signal indicating a time interval Td for the previous switching period to transition from high to low to mark an end time of the time interval Td. Accordingly, the time interval Td can be determined. Therefore, the second predetermined voltage Vth2 for the current switching period can be adjusted, for example, maintained the same, increased or decreased, based on a comparison between the time interval Td for the previous switching period and the predetermined reference interval Tdref.

At t2, the primary transistor switch Q1 is turned off, causing a sharp decrease in the voltage V_Forw from the secondary side winding W2.

At t3, the voltage V_Forw from the secondary side winding W2 drops to the first predetermined voltage Vth1, and the output control signal SR_C of the secondary side controller 100 is inverted high, turning on the synchronous rectifier SR. At this time, a signal indicating a turn-on time Ton of the synchronous rectifier SR is inverted high.

The secondary side controller 100 monitors the voltage V_Forw from the secondary side winding W2 in real time and causes, at t4 (or t5) when the voltage V_Forw from the secondary side winding W2 reaches the adjusted second predetermined voltage Vth2 (or Vth2′), the control signal SR_C that it outputs to transition from high to low, thereby turning off the synchronous rectifier SR. At the same time, the signal indicating the time interval Td is inverted high, marking a start time of a time interval Td for the current switching period. Moreover, the signal indicating the turn-on time Ton of the synchronous rectifier SR is inverted low.

Specifically, if the time interval Td for the previous switching period is longer than the predetermined reference interval Tdref (i.e., Td>Tdref), the second predetermined voltage is increased (e.g., from Vth2 to Vth2′). In this case, at t5, the synchronous rectifier SR is turned off. Accordingly, the signal indicating the time interval Td is inverted high, and the signal indicating the turn-on time Ton of the synchronous rectifier SR is inverted low.

Immediately after the synchronous rectifier SR is turned off, the voltage V_Forw from the secondary side winding W2 will drop to, for example, about −0.7 V due to ongoing demagnetization.

At t6 in the next switching period, the primary transistor switch Q1 is turned on, causing the voltage V_Forw from the secondary side winding W2 to sharply rise.

At t7, the secondary side controller 100 detects that the voltage V_Forw from the secondary side winding W2 reaches the third predetermined voltage Vth3, thereby identifying an ON state of the primary transistor switch Q1. Accordingly, the signal indicating the time interval Td is inverted low, marking an end time of the time interval Td for the current switching period. Therefore, the time interval Td for the current switching period can be determined, and the second predetermined voltage Vth2 for the next switching period can be adjusted, for example, maintained the same, increased or decreased, based on a comparison between the time interval Td for the current switching period and the predetermined reference interval Tdref.

It is to be noted that the embodiments disclosed herein are described in a progressive manner, with the description of each embodiment focusing on its differences from others. Reference can be made between the embodiments for their identical or similar features. Since the system embodiments correspond to the method embodiments, cross-reference can be made therebetween. While the invention has been described above with reference to preferred embodiments thereof, it is not limited to these embodiments. In light of the above teachings, any person familiar with the art may make many possible modifications and variations to the disclosed embodiments or adapt them into equivalent embodiments, without departing from the scope of the invention. Accordingly, it is intended that any and all simple variations, equivalent alternatives and modifications made to the foregoing embodiments based on the substantive disclosure of the invention without departing from the scope thereof fall within the scope.

It is to be understood that, as used herein, the terms “first”, “second”, “third” and the like are only meant to distinguish various components, elements, steps, etc. from each other rather than indicate logical or sequential orderings thereof, unless otherwise indicated or specified. Further, it is also to be recognized that, as used herein and in the appended claims, the singular forms “a” and “an” include the plural reference unless the context clearly dictates otherwise. Thus, for example, a reference to “a step” or “a means” is a reference to one or more steps or means and may include sub-steps and sub-means. All conjunctions used are to be understood in the most inclusive sense possible.

What is claimed is:

1. A control circuit for controlling an isolated power supply, the isolated power supply comprising a primary side circuit, a secondary side circuit and a transformer coupled between the primary side circuit and the secondary side circuit, the control circuit comprising:
a primary side controller having an output terminal electrically connected to a control terminal of a primary transistor switch in the primary side circuit, the primary side controller configured to output a control signal for the primary transistor switch; and
a secondary side controller having an input terminal electrically connected to a secondary side winding in the transformer, the secondary side controller configured to detect a voltage from the secondary side winding, the secondary side controller also having an output terminal electrically connected to a control terminal of a synchronous rectifier in the secondary side circuit, the secondary side controller also configured to output a control signal for the synchronous rectifier,
wherein in the current switching period, the secondary side controller is configured to give an instruction for turning on the synchronous rectifier when the voltage from the secondary side winding drops to a first predetermined voltage as a result of the primary transistor switch being turned off, and give another instruction for turning off the synchronous rectifier when the voltage from the secondary side winding gradually rises back to a second predetermined voltage in a turn-on period of the synchronous rectifier, the second predetermined voltage is adjusted based on a comparison between a time interval from a turn-off time of the synchronous rectifier for the previous switching period to a time when an ON state of the primary transistor switch is identified in the current switching period and a predetermined reference interval.

2. The control circuit of claim 1, wherein the secondary side controller is further configured to identify the ON state of the primary transistor switch upon the voltage from the secondary side winding rising to a third predetermined voltage as a result of the primary transistor switch being turned on.

3. The control circuit of claim 1, wherein if the time interval for the previous switching period is shorter than the predetermined reference interval, the second predetermined voltage is reduced based on a second predetermined voltage for the previous switching period, or
if the time interval for the previous switching period is longer than the predetermined reference interval, the second predetermined voltage is increased based on the second predetermined voltage for the previous switching period.

4. The control circuit of claim 3, wherein the secondary side controller is further configured to: determine the turn-off time of the synchronous rectifier for the previous switching period based on a time when the voltage from the secondary side winding reached the second predetermined voltage in the previous switching period and take it as a start time of the time interval for the previous switching period; identify the time when the primary transistor switch is in the ON state during the current switching period upon the voltage from the secondary side winding rising to a third predetermined voltage as a result of the primary transistor switch being turned on in the current switching period and take this time as an end time of the time interval for the previous switching period; and thereby determine the time interval for the previous switching period.

5. The control circuit of claim 1, wherein the secondary side controller is also configured to generate, while the synchronous rectifier being in an OFF state, a turn-on prompt signal indicating that the primary transistor switch is allowed to be turned on and provide the turn-on prompt signal to the primary side controller.

6. The control circuit of claim 1, wherein the secondary side controller comprises:
an adaptive control module having an input terminal electrically connected to the secondary side winding, the adaptive control module configured to receive the voltage from the secondary side winding, determine a turn-on time of the synchronous rectifier as the time when the voltage from the secondary side winding drops to the first predetermined voltage as a result of the primary transistor switch being turned off and determine the turn-off time of the synchronous rectifier as the time when the voltage from the secondary side winding rises back to the second predetermined voltage as a result of the synchronous rectifier being turned on; and
a secondary side drive control module having an input terminal electrically connected to the adaptive control module and an output terminal electrically connected to the control terminal of the synchronous rectifier, the secondary side drive control module is configured to receive indication signals indicating the turn-on time and the turn-off time of the synchronous rectifier from the adaptive control module and turn on and off the synchronous rectifier based on the indication signals.

7. The control circuit of claim 6, wherein the adaptive control module is further configured to determine, in every switching period, an on-time duration of the synchronous rectifier based on the turn-on time and the turn-off time of the synchronous rectifier.

8. The control circuit of claim 6, wherein the adaptive control module is further configured to adjust the second predetermined voltage for the current switching period based on the comparison between the time interval and the predetermined reference interval.

9. The control circuit of claim 8, wherein the adaptive control module comprises:
a sampling circuit having an input terminal electrically connected to the secondary side winding and configured to sample the voltage from the secondary side winding;
a phase-locked loop circuit having an input terminal electrically connected to the sampling circuit, the phase-locked loop circuit configured to receive the sampled voltage from the secondary side winding, determine the time interval for the previous switching period based on the sampled voltage from the secondary side winding and adjust the second predetermined voltage for the current switching period based on the comparison between the time interval and the predetermined reference interval; and
an on-time duration logic circuit having a first input terminal electrically connected to the sampling circuit and a second input terminal electrically connected to the phase-locked loop circuit, the on-time duration logic circuit configured to determine the turn-on time of the synchronous rectifier as the time when the voltage from the secondary side winding drops to the first predetermined voltage, receive the second predetermined voltage that has been adjusted by the phase-locked loop circuit and determine a turn-off time of the synchronous rectifier as the time when the voltage from the secondary side winding reaches the adjusted second predetermined voltage.

10. The control circuit of claim 9, wherein the phase-locked loop circuit comprises:
a frequency and phase detector having a first input terminal electrically connected to the sampling circuit, the frequency and phase detector configured to receive the sampled voltage from the secondary side winding and produce a pulse-width signal indicating the time interval for the previous switching period based on the sampled voltage from the secondary side winding, the frequency and phase detector also having a second input terminal for receiving a reference pulse-width signal indicating the predetermined reference interval, the frequency and phase detector also configured to compare the pulse-width signal indicating the time interval for the previous switching period with the reference pulse-width signal and provide a frequency and phase detection result;
a current generation unit electrically connected to the frequency and phase detector, the current generation unit configured to: receive the frequency and phase detection result; and generate and output a pull-down current signal if the pulse-width signal indicating the time interval for the previous switching period has a shorter pulse width than the reference pulse-width signal, or generate and output a pull-up current signal of the pulse-width signal indicating the time interval for the previous switching period has a longer pulse width than the reference pulse-width signal;
a low-pass filter having an input terminal electrically connected to the current generation unit, the low-pass filter configured to apply low-pass filtering to the output of the current generation unit, the low-pass filter comprising at least one capacitor, which is charged when the pull-up current signal is received from the current generation unit, or is discharged when the pull-down current signal is received from the current generation unit; and
a threshold adjustment unit having an input terminal electrically connected to the low-pass filter, the threshold adjustment unit configured to receive an output voltage from the low-pass filter and obtain the second predetermined voltage for the current switching period by adjusting a second predetermined voltage for the previous switching period based on the output voltage.

11. The control circuit of claim 8, wherein the adaptive control module comprises:
a sampling circuit having an input terminal electrically connected to the secondary side winding and configured to sample the voltage from the secondary side winding; and
a pulse-width comparator having a first input terminal electrically connected to the sampling circuit, the pulse-width comparator configured to produce a pulse-width signal indicating the time interval for the previous switching period based on the voltage from the secondary side winding, the pulse-width comparator also having a second input terminal for receiving a reference pulse-width signal indicating the predetermined reference interval, the pulse-width comparator also configured to compare the pulse-width signal indicating the time interval for the previous switching period with the reference pulse-width signal and provide a pulse-width comparison result.

12. The control circuit of claim 11, wherein the adaptive control module further comprises:
an up/down counter having an input terminal electrically connected to the pulse-width comparator, the up/down counter configured to receive the pulse-width comparison result, determine a count value based on the pulse-width comparison result and produce a counting result based on the count value and a predetermined reference value, wherein if the pulse-width comparison result indicates that the time interval for the previous switching period has a longer pulse width than the reference pulse-width signal, the count value is determined as a positive value, and an output voltage value is increased based on the predetermined reference value and taken as the counting result, or if the pulse-width comparison result indicates that the time interval for the previous switching period has a shorter pulse width than the reference pulse-width signal, the count value is determined as a negative value, and the output voltage value is decreased based on the predetermined reference value and taken as the counting result;
a threshold adjustment unit having an input terminal for receiving an analog signal indicating the counting result, the threshold adjustment unit configured to tune the second predetermined voltage for the previous switching period into the second predetermined voltage for the current switching period based on the analog signal; and
an on-time duration logic circuit having a first input terminal electrically connected to the sampling circuit and a second input terminal electrically connected to the threshold adjustment unit, the on-time duration logic circuit configured to determine the turn-on time of the synchronous rectifier as the time when the voltage from the secondary side winding drops to the first predetermined voltage, receive the second predetermined voltage that has been adjusted by the threshold adjustment unit and determine a turn-off time of the synchronous rectifier as the time when the voltage from the secondary side winding reaches the adjusted second predetermined voltage.

13. The control circuit of claim 6, wherein the secondary side controller further comprises:
a logic module having a second input terminal electrically connected to the secondary side drive control module, the logic module configured to receive from the secondary side drive control module an off-state signal indicating an off-state of the synchronous rectifier and generate a turn-on prompt signal indicating that the primary transistor switch is allowed to be turned on; and
a transmitter module having an input terminal electrically connected to the logic module and an output terminal electrically connected to the primary side controller, the transmitter module configured to receive the turn-on prompt signal and pass the turn-on prompt signal on to the primary side controller.

14. The control circuit of claim 13, wherein the secondary side controller further comprises:
a loop module having an input terminal for receiving an output voltage of the isolated power supply and an output terminal electrically connected to a first input terminal of the logic module, the loop module configured to generate a feedback signal based on the output voltage of the isolated power supply and provide the feedback signal to the logic module; and
the logic module configured to generate the turn-on prompt signal based on the off-state signal and the feedback signal.

15. An isolated power supply, comprising the control circuit of claim 1.
